(19) United States
(12) Patent Application Publication
(10) Pub. No.: US 2010/0093192 A1
(43) Pub. Date: Apr. 15, 2010

(54) CONNECTION STRUCTURE BETWEEN SIGNAL TRANSMITTING BOARDS

(76) Inventor: Ke-Feng Lin, Tu-Cheng City (TW)

Correspondence Address: Muncy, Geissler, Olds & Lowe, PLLC, P.O. BOX 1364, FAIRFAX, VA, 22038-1364, US

(21) Appl. No.: 12/250,871

(22) Filed: Oct. 14, 2008

(51) Int. Cl. H01R 12/00

(52) U.S. Cl. 439/67

(57) ABSTRACT

A connection structure between signal transmitting boards includes a flexible signal transmitting board and a generic signal transmitting board. The generic signal transmitting board has a transmitting base which defines a limiting opening. The flexible signal transmitting board has a flexible base positioned at a side of the transmitting base. The flexible base defines a positioning slice which extends to the other side of the transmitting base via the limiting opening for locating the generic signal transmitting board and the flexible signal transmitting board together.

### BACKGROUND OF THE INVENTION

1. Field of the Invention

This present invention relates to a connection structure between two signal transmitting boards, and more specifically to a connection structure between a flexible signal transmitting board and a generic signal transmitting board.

2. The Related Art

Conventionally, a flexible signal transmitting board such as a flexible printed circuit board (FPCB) is arranged in an electronic device to transmit signals between the flexible signal transmitting board and a generic signal transmitting board both of which are connected with each other. The common usage is that the flexible signal transmitting board is fixed on the generic signal transmitting board by a double sided adhesive tape, and then the flexible signal transmitting board is welded on the generic signal transmitting board.

However, the disadvantage of using the double sided adhesive tape is that the material and the time of assembling the flexible signal transmitting board with the generic signal transmitting board is wasted, and what more, the double sided adhesive tape is stuck on the flexible signal transmitting board, so that the double sided adhesive tape occupies the space of the electronic device, and meanwhile the flexibility of the flexible signal transmitting board is reduced.

### SUMMARY OF THE INVENTION

An object of the invention is to provide an improved connecting structure between signal transmitting boards. The connection structure includes a flexible signal transmitting board and a generic signal transmitting board. The generic signal transmitting board has a transmitting base which defines a limiting opening. The flexible signal transmitting board has a flexible base positioned at a side of the transmitting base. The flexible base defines a positioning slice which extends to the other side of the transmitting base via the limiting opening for locating the generic signal transmitting board and the flexible signal transmitting board together.

As above description, the positioning slice extends to the other side of the transmitting base via the limiting opening, so the generic signal transmitting board and the flexible signal transmitting board are positioned together relative to each other for conveniently being welded. The connection structure is simple and easy to operate and ensures the flexibility of the flexible signal transmitting board.

### BRIEF DESCRIPTION OF THE DRAWINGS

The invention, together with its objects and the advantages thereof may be best understood by reference to the following description taken in conjunction with the accompanying drawings, in which:

FIG. 1 is a perspective view of a first embodiment of a connection structure between a flexible signal transmitting board and a generic signal transmitting board according to the present invention;

FIG. 2 is another perspective view of the first embodiment of the connection structure between the flexible signal transmitting board and the generic signal transmitting board of FIG. 1;

FIG. 3 is a perspective view of a second embodiment of a connection structure between a flexible signal transmitting board and a generic signal transmitting board according to the present invention;

FIG. 4 is a perspective view of a third embodiment of a connection structure between a flexible signal transmitting board and a generic signal transmitting board according to the present invention; and

FIG. 5 is a perspective view of a fourth embodiment of a connection structure between a flexible signal transmitting board and a generic signal transmitting board according to the present invention.

### DETAILED DESCRIPTION OF THE PREFERRED EMBODIMENTS

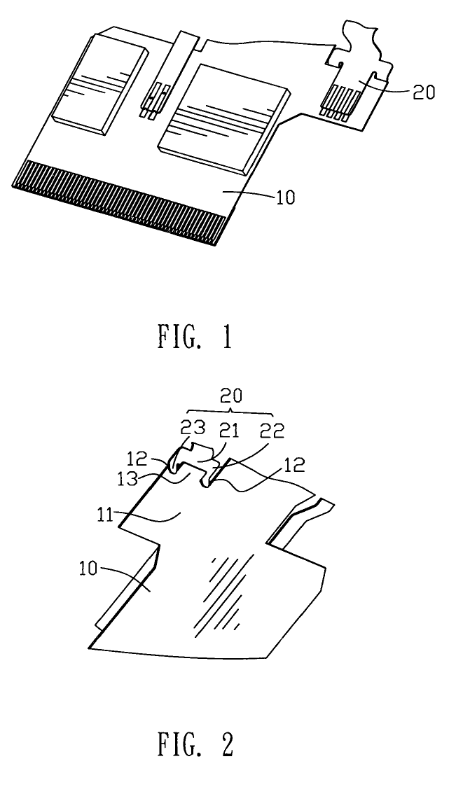

Referring to FIGS. 1 and 2, a first embodiment of a connection structure between a flexible signal transmitting board 20 and a generic signal transmitting board 10 according to the invention is disclosed. The generic signal transmitting board 10 has a transmitting base 11. An edge of the transmitting base 11 defines two spaced limiting gaps 12, a limiting slice 13 is formed between the two limiting gaps 12. The flexible signal transmitting board 20 has a flexible base 21. A portion of the flexible base 21 extends oppositely to form two opposite extending portions 22, two positioning slices 23 are extended towards the same direction and spaced from the flexible base 21. The distance between the two positioning slices 23 matches with the width of the limiting slice 13.

When the generic signal transmitting board 10 and the flexible signal transmitting board 20 are assembled together, the flexible base 21 is arranged on an upper surface of the transmitting base 11. The two positioning slices 23 passes through the corresponding limiting gaps 12 to be positioned at a lower surface opposite to the upper surface of the transmitting base 71 and locating the limiting slice 13 therebetween for locating the generic signal transmitting board 10 and the flexible signal transmitting board 20 together. Then generic the signal transmitting board 10 and the flexible signal transmitting board 20 are welded jointly in a following process.

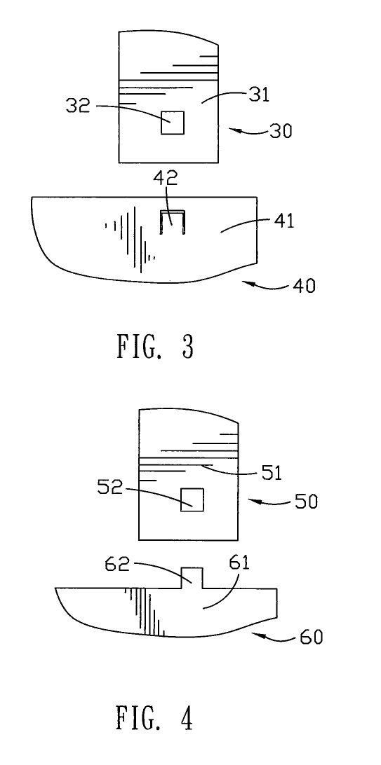

Referring to FIG. 3, a second embodiment of a connection structure between a flexible signal transmitting board 40 and a generic signal transmitting board 30 according to the invention is disclosed. The generic signal transmitting board 30 has a transmitting base 31 which defines a limiting hole 32 therein. The flexible signal transmitting board 40 has a flexible base 41. A rectangular positioning slice 42 is formed at the middle of the flexible base 41 in manner of cutting. The width of the positioning slice 42 matches with the width of the limiting hole 32. When the generic signal transmitting board 30 and the flexible signal transmitting board 40 are assembled together, the flexible base 41 is arranged on an upper surface of the transmitting base 31 of the signal transmitting board 30. The positioning slice 42 passes through the limiting hole 32 to be positioned at a lower surface opposite to the upper surface of the transmitting base 31 for locating the generic signal transmitting board 30 and the flexible signal transmitting board 40 together. Then the generic signal transmitting board 30 and the flexible signal transmitting board 40 are welded jointly in a following process.

Please refer to FIG. 4. A third embodiment of a connection structure between a flexible signal transmitting board 60 and a generic signal transmitting board 50 according to the invention is disclosed. The generic signal transmitting board 50 has a transmitting base 51 which defines a limiting hole 52 therein. The flexible signal transmitting board 60 has a flexible base 61. A positioning slice 62 protrudes outward from an edge of the flexible base 61. When the generic signal transmitting board 50 and the flexible signal transmitting board 60 are assembled together, the flexible base 61 is arranged on an upper surface of the transmitting base 51 of the generic signal transmitting board 50. The positioning slice 62 passes through the limiting hole 52 to be positioned at a lower surface opposite to the upper surface of the transmitting base 51 for locating the flexible signal transmitting board 60 and the generic signal transmitting board 50 together, and then the flexible signal transmitting board 60 is easily welded on the generic signal transmitting board 50.

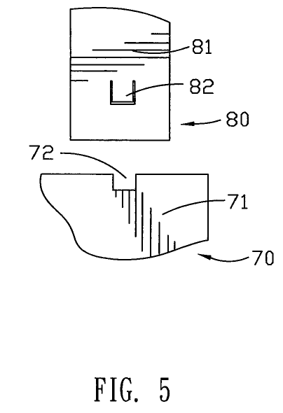

Please refer to FIG. 5. A fourth embodiment of a connection structure between a flexible signal transmitting board 80 and a generic signal transmitting board 70 according to the invention is disclosed. The generic signal transmitting board 70 has a transmitting base 71. An edge of the transmitting base 71 defines a limiting gap 72. The flexible signal transmitting board 80 has a flexible base 81, a positioning slice 82 is formed in a middle of the flexible base 81 in manner of cutting. When the generic signal transmitting board 70 and the flexible signal transmitting board 80 are assembled together, the flexible base 81 is arranged on an upper surface of the transmitting base 71 of the generic signal transmitting board 70. The positioning slice 82 passes through the limiting gap 72 to be positioned at a lower surface opposite to the upper surface of the transmitting base 71 for locating the flexible signal transmitting board 80 and the generic signal transmitting board 70 together, and then the flexible signal transmitting board 80 is easily welded on the generic signal transmitting board 70.

As above description, when the generic signal transmitting board and the flexible signal transmitting board are assembled together, the flexible base is arranged on one side of the transmitting base of the generic signal transmitting board, the positioning slice extends to the other side of the transmitting base via the limiting opening or the limiting gap, so the generic signal transmitting board and the flexible signal transmitting board are positioned together relative to each other for conveniently being welded. The connection structure is simple and easy to operate and ensures the flexibility of the flexible signal transmitting board.

Embodiments of the present invention have been discussed in detail. However, these embodiments are merely a specific example for clarifying the technical contents of the present invention and the present invention is not to be construed in a restricted sense as limited to these specific examples. Thus, the spirit and scope of the present invention are limited only by the appended claims.

What is claimed is:

1. A connection structure between signal transmitting boards, comprising:
a generic signal transmitting board having a transmitting base which defines a limiting opening; and
a flexible signal transmitting board having a flexible base positioned at one side of the transmitting base, the flexible base defining a positioning slice which extends to the other side of the transmitting base via the limiting opening for locating the generic signal transmitting board and the flexible signal transmitting board together.

2. The connection structure between signal transmitting boards as set forth in claim 1, wherein the limiting opening of the generic signal transmitting board is a limiting gap, an edge of the transmitting base defines two spaced said limiting gaps, a limiting slice is formed between the two limiting gaps, a portion of the flexible base extends oppositely to form two opposite extending portions, two said positioning slices are extended substantially towards the same direction and spaced from the flexible base, the positioning slices extends to the other side of the transmitting base via the corresponding limiting gaps.

3. The connection structure between signal transmitting boards as set forth in claim 1, wherein the limiting opening of the generic signal transmitting board is a limiting hole defined in the transmitting base, the positioning slice is formed in the flexible base in manner of cutting, the positioning slice extends to the other side of the transmitting base via the limiting hole.

4. The connection structure between signal transmitting boards as set forth in claim 1, wherein the limiting opening of the generic signal transmitting board is a limiting hole defined in the transmitting base, the positioning slice extends from an edge of the flexible base, the positioning slice extends to the other side of the transmitting base via the limiting hole.

5. The connection structure between signal transmitting boards as set forth in claim 1, wherein the limiting opening of the generic signal transmitting board is a limiting gap defined at an edge of the transmitting base, the positioning slice is formed in the flexible base in manner of cutting, the positioning slice extends to the other side of the transmitting base via the limiting gap.
